(19) United States
(12) Patent Application Publication
(10) Pub. No.: US 2022/0071082 A1
(43) Pub. Date: Mar. 10, 2022

(54) METHOD AND APPARATUS FOR DETERMINING AN AMOUNT OF NITROGEN-STABILIZING ADDITIVE

(71) Applicant: BASF SE, Ludwigshafen (DE)

(72) Inventors: Wolfram ZERULLA, St Martin (DE); Markus SCHMID, Limburgerhof (DE); Gregor PASDA, Limburgerhof (DE); Alexander WISSEMEIER, Limburgerhof (DE)

(21) Appl. No.: 17/431,066

(22) PCT Filed: Feb. 13, 2020
(86) PCT No.: PCT/IB2020/051179

§ 371 Date: Aug. 13, 2021

(30) Foreign Application Priority Data
Feb. 14, 2019 (EP) 19157267.6

(51) Int. Cl. A01B 79/00; A01C 21/00; C05G 3/90

(52) U.S. Cl. CPC A01B 79/005; C05G 3/90; A01C 21/007

(57) ABSTRACT

A method for determining an amount of a nitrogen-stabilizing additive selected from nitrification inhibitors, urease inhibitors and denitrification inhibitors, to be applied jointly or separately with a nitrogen containing fertilizer, comprising determining values of at least two parameters influencing the efficacy of the nitrogen-stabilizing additive, determining an amount of nitrogen containing fertilizer that has been applied or is to be applied, determining the efficacy of the nitrogen-stabilizing additive on the basis of said values of said at least two parameters and calculating the necessary amount of nitrogen-stabilizing additive to be applied on the basis of said efficacy of the nitrogen-stabilizing additive and of said amount of nitrogen-containing fertilizer application. Furthermore, the method relates to an apparatus (1) for determining an amount of a nitrogen-stabilizing additive.

The present invention relates to a method for determining an amount of a nitrogen-stabilizing additive selected from nitrification inhibitors, urease inhibitors and denitrification inhibitors, to be applied jointly or separately with a nitrogen-containing fertilizer. Moreover, the invention relates to an apparatus for determining an amount of such a nitrogen-stabilizing additive.

Chemical fertilizers are essential for obtaining high yields in agriculture. Nitrogen fertilizers like urea show low efficiencies when applied to field crops and contribute to environmental pollution. Nitrogen losses occur as a result of organic and/or mineral fertilization and tillage. These are mainly ammonia losses and losses resulting from either nitrogen leaching or the release of nitrous oxide into the atmosphere. While nitrogen losses generally result in an economic cost for the grower, they also have a negative impact on the environment. Nitrogen-stabilizing additives are useful in reducing nitrogen fertilizer requirement, improving crop yields and quality, reducing nitrogen losses, minimizing environmental pollution and increasing fertilizer use efficiency.

Nitrification inhibitors can retard or prevent the conversion of ammonium-nitrogen to nitrate-nitrogen by nitrifying bacteria in soil. Application of an inhibitor with ammonium or ammonium-forming fertilizers, e. g. urea, will limit the formation of nitrate which, unlike ammonium, is susceptible to loss from soil by leaching and denitrification. A urease inhibitor effectively prevents the conversion of urea into carbamic acid and ammonia by blocking the enzyme that drives the conversion, i.e., urease. Denitrification inhibitors retard or prevent the microbiological conversion of nitrate (NO₃⁻) and nitrite (NO₂⁻) to gaseous forms of nitrogen, generally N₂ or N₂O.

The efficacy of the nitrogen-stabilizing additive is, however, dependent on specific conditions, such as the soil quality and climatic conditions, thus showing variable potency. These specific conditions may vary even within spatially contiguous areas, such as within one working area of a field. As such it is desirable to adjust the amount of nitrogen-stabilizing additive to be applied in connection with a nitrogen-containing fertilizer in order to optimize efficacy of the nitrogen-stabilizing additive and increase fertilizer use efficiency. There is a need for providing a quick and easy way to determine the amount of nitrogen-stabilizing additive.

It is, therefore, the object of the present invention to provide a method and an apparatus for determining an amount of a nitrogen-stabilizing additive that is optimized for application together with a nitrogen-containing fertilizer.

This object has been achieved by a method as defined in claim 1 and an apparatus as defined in claim 12. Further features of this method and apparatus are defined in the dependent claims.

The invention devises a method for determining an amount of nitrogen-stabilizing additive selected from nitrification inhibitor inhibitors, urease inhibitors and denitrification inhibitor inhibitors, to be applied jointly or separately with a nitrogen-containing fertilizer, comprising

(a) determining values of at least two parameters influencing the efficacy of the nitrogen-stabilizing additive;

(b) determining an amount of nitrogen-containing fertilizer that has been applied or is to be applied;

(c) determining the efficacy of the nitrogen-stabilizing additive on the basis of said values of said at least two parameters

(d) calculating the necessary amount of nitrogen-stabilizing additive to be applied on the basis of said efficacy of the nitrogen-stabilizing additive and of said amount of nitrogen-containing fertilizer application.

It has been found that the calculation of the necessary amount of nitrogen-stabilizing additive depends not only on the amount of application of a nitrogen-containing fertilizer but advantageously also on at least two parameters influencing the efficiency of the nitrogen-stabilizing additive. In particular, the ratio of the amount of nitrogen-stabilizing additive and the amount of nitrogen-containing fertilizer is calculated based on the values of the at least two parameters.

The method of the present invention provides the advantage that the farmer gets more yield on the field and/or needs less fertilizer. He can achieve more yield with the same amount of fertilizer by applying the calculated amount of nitrogen stabilizer. However, he can also achieve the same yield with less fertilizer by applying the calculated amount of nitrogen stabilizer.

The efficacy of the nitrogen-stabilizing additive is determined by using a nitrogen-stabilizing additive efficacy formula. The nitrogen-stabilizing additive efficacy formula is preferably stored in a local or external database. The nitrogen-stabilizing additive efficacy formula uses mathematical calculation or reference to empirical data.

According to an embodiment of the invention, the time of an application or the time of an estimated application of the nitrogen-containing fertilizer is determined. In this case, the necessary amount of nitrogen-stabilizing additive to be applied is calculated on the basis of said efficacy of the nitrogen-stabilizing additive and of said amount and time of the nitrogen-containing fertilizer application. This embodiment is particularly advantageous if there will be a significant difference between the value of a parameter that is used for determining the efficacy of the nitrogen-stabilizing additive at the present time and the respective value at the time or estimated time of the application of the nitrogen-containing fertilizer. The calculated amount for the nitrogen-stabilizing additive can then be matched to the actual time of application of the nitrogen-containing fertilizer.

The parameters may include two or more of soil temperature, soil clay content, soil sand content, soil pH, organic matter content of the soil, soil compaction, biological activity of soil, CEC (cation exchange capacity) and total nitrogen content of soil, nitrate and/or ammonium content of soil, type of cultivated plant, amount of precipitation, time of amount of precipitation, time interval until forecasted rainfall, forecasted rainfall quantity, wind strength, geographical position, and the time interval between nitrogen-containing fertilizer application and nitrogen-stabilizing additive application.

At least one value of said at least two parameters may be provided by a user's input. For example, the user may enter a value of a particular parameter so that such value may be taken into consideration for the calculation of the necessary amount of nitrogen-stabilizing additive.

At least one value of said at least two parameters may be provided by an automated access to a database. For example, a central database may be provided so that users at different locations may access such database by a network such as the internet. Such database may be provided by the manufacturer of the nitrogen-stabilizing additive so that particular parameters that influence the efficacy of the nitrogen-stabilizing additive can be maintained centrally by the manufacture of the additive.

At least one value of said at least two parameters may be provided by an automated measurement. Advantageously, the value can be obtained from a relevant sensor which is appropriately located or temporarily moved to a measurement position by the user.

It is to be noted that one or more parameters may comprise several sub-parameters that indicate values of the parameter at different times. In this case, temporal changes may be taken into account for the calculation of the necessary amount of nitrogen-stabilizing additive.

At least one value of said at least two parameters may be provided by a forecast of a future value of this parameter. The forecast may involve a forecast of rainfall, air temperature, date of rainfall event and/or rainfall quantity. By taking a forecast of a future value of a parameter into account, a highly accurate calculation of the necessary amount of nitrogen-stabilizing additive may be carried out by the method of the present invention.

The term “fertilizers” is to be understood as chemical compounds applied to promote plant and fruit growth. Fertilizers are typically applied either through the soil or soil substituents for uptake by plant roots or directly by plant leaves. The term also includes mixtures of one or more different types of fertilizers as mentioned below. The term “fertilizers” can be subdivided into several categories including: a) organic fertilizers (composed of decayed plant/animal matter), b) inorganic fertilizers (composed of chemicals and minerals) and c) urea-containing fertilizers.

The term “nitrogen-containing” means that the fertilizer contains at least one nitrogen component, also termed nitrogen source. Such nitrogen sources include inorganic compounds, in particular ammonium salts, such as ammonium sulfate, ammonium nitrate, ammonium sulfate nitrate, diammonium phosphate, monoammonium phosphate and ammonium thiosulfate; inorganic nitrates such as calcium nitrate and potassium nitrate; inorganic cyanamides such as calcium cyanamide; and organic compounds such as urea, urea derivatives such as methylene urea, isobutylidene diurea, crotonylidene diurea, acetylene diurea, dimethylene triurea, tri methylene tetraurea, tri methylene pentaurea, substituted triazones and triuret, and proteins and mixtures of different nitrogen sources. The nitrogen-containing fertilizer may contain the nitrogen source as the sole fertilizing component or it may additionally contain other fertilizing components, which are different therefrom.

Nitrogen-containing fertilizers may be provided in any suitable form, e.g. as coated or uncoated granules, in liquid or semi-liquid form, as sprayable fertilizer, or in a form of a material obtained by fertigation of organic matter. For example at least the following nitrogen-containing fertilizers or combinations thereof may be used:

Organic nitrogen-containing fertilizers include manure, e.g. liquid manure, semi-liquid manure, liquid dung-water, biogas manure, stable manure or straw manure, slurry, sewage sludge, worm castings, peat, seaweed, compost, sewage, and guano. Green manure crops are also regularly grown to add nutrients (especially nitrogen) to the soil. Manufactured organic fertilizers include compost, blood meal, bone meal and seaweed extracts. Further examples are enzyme digested proteins, fish meal, and feather meal. The decomposing crop residue from prior years is another source of fertility.

Inorganic nitrogen-containing fertilizers are usually manufactured through chemical processes (such as the Haber-Bosch process), also using naturally occurring deposits, while chemically altering them (e.g. concentrated triple superphosphate). Naturally occurring inorganic fertilizers include Chilean sodium nitrate, mine rock phosphate, limestone, and raw potash fertilizers, the latter being used as additional components in nitrogen-containing fertilizers.

Typical solid fertilizers may be in a crystalline, prilled or granulated form. Typical nitrogen containing inorganic fertilizers are ammonium nitrate, calcium ammonium nitrate, ammonium sulfate, ammonium sulfate nitrate, calcium nitrate, diammonium phosphate, monoammonium phosphate, ammonium thio sulfate and calcium cyanamide. Besides solid fertilizers also liquid fertilizers (e.g. UAN) are available.

The inorganic fertilizer may be an NPK fertilizer. “NPK fertilizers” are inorganic fertilizers formulated in appropriate concentrations and combinations comprising the three main nutrients nitrogen (N), phosphorus (P) and potassium (K) as well as typically S, Mg, Ca, and trace elements. “NK fertilizers” comprise the two main nutrients nitrogen (N) and potassium (K) as well as typically S, Mg, Ca, and trace elements. “NP fertilizers” comprise the two main nutrients nitrogen (N) and phosphorus (P) as well as typically S, Mg, Ca, and trace elements. NPK, NK and NP fertilizers can be produced chemically or by a mixture of its single components.

Urea-containing fertilizer may be urea, formaldehyde urea, urea sulfur, urea based NPK-fertilizers, urea ammonium nitrate (UAN) or urea ammonium sulfate. Also envisaged is the use of urea as fertilizer. In case urea-containing fertilizers or urea are used or provided, it is particularly preferred that urease inhibitors as below may be added or additionally be present, or be used at the same time or in connection with the urea-containing fertilizers.

In further embodiments the fertilizer mixture may be provided as, or may comprise or contain a slow release fertilizer. The fertilizer may, for example, be released over any suitable period of time, e.g. over a period of 1 to 5 months, preferably up to 3 months. Typical examples of ingredients of slow release fertilizers are IBDU (isobutylidene diurea), e.g. containing about 31-32% nitrogen, of which 90% is water insoluble; or UF, i.e. an urea-formaldehyde product which contains about 38% nitrogen of which about 70% may be provided as water insoluble nitrogen; or CDU (crotonylidene diurea) containing about 32% nitrogen; or MU (methylene urea) containing about 38 to 40% nitrogen, of which 25-60% is typically cold water insoluble nitrogen; or MDU (methylene diurea) containing about 40% nitrogen, of which less than 25% is cold water insoluble nitrogen; or DMTU (dimethylene triurea) containing about 40% nitrogen, of which less than 25% is cold water insoluble nitrogen; or TMTU (tri methylene tetraurea), which may be provided as component of UF products; or TMPU (tri methylene pentaurea), which may also be provided as component of UF products. The fertilizer mixture may also be long-term nitrogen-bearing fertilizer containing a mixture of acetylene diurea and at least one other organic nitrogen-bearing fertilizer selected from methylene urea, isobutylidene diurea, crotonylidene diurea, substituted triazones, triuret or mixtures thereof.

The nitrogen-containing fertilizer may be a coated nitrogen-containing fertilizer. Coated nitrogen-containing fertilizers may be provided with a wide range of materials. Coatings may, for example, be applied to granular or prilled nitrogen (N) fertilizer or to multi-nutrient fertilizers. Typically, urea is used as base material for most coated fertilizers. The present invention, however, also envisages the use of other nitrogen-containing base materials for coated fertilizers, any one of the fertilizer materials defined herein. In certain embodiments, elemental sulfur may be used as fertilizer coating. The coating may be performed by spraying molten S over urea granules, followed by an application of sealant wax to close fissures in the coating. In a further embodiment, the S layer may be covered with a layer of organic polymers, preferably a thin layer of organic polymers. In another embodiment, the coated fertilizers are preferably physical mixtures of coated and non-coated fertilizers.

Further envisaged coated nitrogen-containing fertilizers may be provided by reacting resin-based polymers on the surface of the nitrogen-containing fertilizer granule. A further example of providing coated nitrogen-containing fertilizers includes the use of low permeability polyethylene polymers in combination with high permeability coatings.

In specific embodiments the composition and/or thickness of the fertilizer coating may be adjusted to control, for example, the nutrient release rate for specific applications. The duration of nutrient release from specific fertilizers may vary, e.g. from several weeks to many months. The presence of nitrification inhibitors and/or urease inhibitors in a mixture with coated fertilizers may accordingly be adapted. It is, in particular, envisaged that the nutrient release involves or is accompanied by the release of a nitrification inhibitor and a urease inhibitor compound.

Coated fertilizers may be provided as controlled release fertilizers (CRFs). In specific embodiments these controlled release fertilizers are fully coated N—P—K fertilizers, which are homogeneous and which typically show a pre-defined longevity of release. In further embodiments, the CRFs may be provided as blended controlled release fertilizer products which may contain coated, uncoated and/or slow release components. In certain embodiments, these coated fertilizers may additionally comprise micronutrients. In specific embodiments these fertilizers may show a pre-defined longevity, e.g. in case of N—P—K fertilizers.

Additionally envisaged examples of CRFs include patterned release fertilizers. These fertilizers typically show a pre-defined release patterns (e.g. hi/standard/lo) and a pre-defined longevity. In exemplary embodiments fully coated N—P—K, Mg and micronutrients may be delivered in a patterned release manner.

Also envisaged are double coating approaches or coated fertilizers based on a programmed release.

Any of the above mentioned fertilizers or fertilizer forms may suitably be combined. For instance, slow release fertilizers may be provided as coated fertilizers. They may also be combined with other fertilizers or fertilizer types. The same applies to the presence of a nitrification inhibitor and/or urease inhibitor and/or denitrification inhibitor according to the present invention, which may be adapted to the form and chemical nature of the fertilizer and accordingly be provided such that its release accompanies the release of the fertilizer, e.g. is released at the same time or with the same frequency. The present invention further envisages fertilizer or fertilizer forms as defined herein above in combination with nitrification inhibitors and/or urease inhibitors and/or denitrification inhibitors. Such combinations may be provided as coated or uncoated forms and/or as slow or fast release forms. Preferred are combinations with slow release fertilizers including a coating. In further embodiments, also different release schemes are envisaged, e.g. a slower or a faster release.

Any of the above mentioned fertilizers or fertilizer forms may suitably be combined.

Nitrogen-stabilizing additives may be selected from nitrification inhibitors, urease inhibitors and denitrification inhibitors.

The term “nitrification inhibitors” is to be understood as any chemical substance which slows down or stops the nitrification process. Nitrification inhibitors retard the natural transformation of ammonium into nitrate, by inhibiting the activity of bacteria such as Nitrosomonas spp. and/or Archaea. The term “nitrification” is to be understood as the biological oxidation of ammonia (NH₃) or ammonium (NH₄⁺) with oxygen into nitrite (NO₂⁻) followed by the oxidation of these nitrites into nitrates (NO₃⁻) by microorganisms. Besides nitrate (NO₃⁻) nitrous oxide is also produced though nitrification. Nitrification is an important step in the nitrogen cycle in soil.

The term “denitrification” is to be understood as the microbiological conversion of nitrate (NO₃⁻) and nitrite (NO₂⁻) to gaseous forms of nitrogen, generally N₂ or N₂O. This respiratory process reduces oxidized forms of nitrogen in response to the oxidation of an electron donor such as organic matter. The preferred nitrogen electron acceptors in order of most to least thermodynamically favorable include: nitrate (NO₃⁻), nitrite (NO₂⁻), nitric oxide (NO), and nitrous oxide (N₂O). Within the general nitrogen cycle, denitrification completes the cycle by returning N₂ to the atmosphere. The process is performed primarily by heterotrophic bacteria (such as Paracoccus denitrificans and various pseudomonads), although autotrophic denitrifiers have also been identified (e.g. Thiobacillus denitrificans). Denitrifiers are represented in all main phylogenetic groups. When faced with a shortage of oxygen many bacterial species, are able switch from using oxygen to using nitrates to support respiration in a process known as denitrification, during which the water-soluble nitrates are converted to gaseous products, including nitrous oxide, that are emitted into the atmosphere.

“Nitrous oxide”, commonly known as happy gas or laughing gas, is a chemical compound with the chemical formula N₂O. At room temperature, it is a colorless non-flammable gas. Nitrous oxide is produced naturally in soils through the microbial processes of nitrification and denitrification.

Examples of nitrification inhibitors include f 2-(3,4-dimethyl-pyrazol-1-yl)-succinic acid and the salts thereof, 2-(4,5-dimethyl-1H-pyrazol-1-yl)succinic acid and the salts thereof, 3,4-dimethyl pyrazole (DMP), 3,4-dimethyl pyrazole derivatives, in particular acid addition salts thereof such as 3,4-dimethylpyrazolephosphate (DMPP, ENTEC), 3,5-dimethyl pyrazole, 3,5-dimethylpyrazole phosphate, 4,5-dimethyl pyrazole phosphate mixtures of 3,4-dimethylpyrazole phosphate succinic acid and 4,5-dimethylpyrazole phosphate succinic acid, the glycolic acid addition salt of 3,4-dimethyl pyrazole, the citric acid addition salt of 3,4-dimethyl pyrazole, the lactic acid addition salt of 3,4-dimethyl pyrazole and the mandelic acid addition salt of 3,4-dimethyl pyrazole, 3-methylpyrazole (3-MP), 4-chloro-3-methylpyrazole and the salts thereof, N-(1H-pyrazolyl-methyl)acetamides such as N-((3(5)-methyl-1H-pyrazole-1-yl)methyl)acetamide, and N-(1H-pyrazolyl-methyl)formamides such as N-((3(5)-methyl-1H-pyrazole-1-yl)methyl)formamide, N-((3(5),4-dimethylpyrazole-1-yl)methyl)formamide, N-((4-chloro-3(5)-methyl-pyrazole-1-yl)methyl)formamide, dicyandiamide (DCD), 1H-1,2,4-triazole and the salts thereof, a reaction adduct of dicyandiamide, urea and formaldehyde, a triazonyl-formaldehyde-dicyandiamide adduct, 2-chloro-6-(trichloromethyl)-pyridine (nitrapyrin or N-serve), 2-cyano-1-((4-oxo-1,3,5-triazinan-1-yl)methyl)guanidine, 1-((2-cyanoguanidino)methyl)urea, 2-cyano-1-((2-cyanoguanidino)methyl)guanidine, 5-ethoxy-3-trichloromethyl-1,2,4-thiadiazol, sodium azide, potassium azide, 1-hydroxypyrazole, 2-methylpyrazole-1-carboxamide, 4-amino-1,2,4-triazole, 3-mercapto-1,2,4-triazole, 2,4-diamino-6-trichloromethyl-5-triazine, carbon bisulfide, sodium trithiocarbonate, 2,3-dihydro-2,2-dimethyl-7-benzofuranol methyl carbamate, N-(2,6-dimethylphenyl)-N-(methoxyacetyl)-alanine methyl ester, linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), neem, products based on ingredients of neem, cyan amide, melamine, zeolite powder, catechol, benzoquinone, chlorate salts, allylthiourea, sodium tetra borate and zinc sulfate.

Fertilizers which are suitable to combine the above-mentioned nitrification inhibitors are urea and/or ammonium-containing N-organic and inorganic fertilizers, as described above.

Examples of envisaged urease inhibitors include:

p-benzoquinone, polyphenols, heterocyclic mercaptans, polyacrylamides and derivatives thereof, dihydroxamic acids, aminocresols, aminophenols, bromo-nitro compounds, thiourea, hydroxamates, sodium chloride, sodium carbonate, urea phosphate, urea nitrate, ammonium thiosulfate, calcium chloride, fluoride salts, O-diaminophosphinyl oximes, phosphinyl sulfamides, phosphorodiamidates, polyphosphorodiamides, cyclotriphosphazatrienes, N-acylphosphoric triamides, metal phosphorylesters, S-aryl(alkyl) diamidophosphorothiolates, N-(n-butyl)thiophosphoric acid triamide (NBPT), N-(n-propyl)thiophosphoric acid triamide (NPPT), mixtures comprising N-(n-butyl)thiophosphoric acid triamide (NBPT) and N-(n-propyl)thiophosphoric acid triamide (NPPT), mixtures comprising N-(n-butyl) thiophosphoric acid triamide (NBPT) and N-(n-propyl) thiophosphoric acid triamide (NPPT) wherein NBPT is contained in amounts of from 50 to 90 wt. % and NPPT is contained in amounts of from 10 to 50 wt. % based on the total amount of active urease inhibitors, phenylphosphorodiamidate (PPD/PPDA), 2-nitrophenyl phosphoric triamide (2-NPT), 2,5-dimethyl-1,4-benzoquinone, hydroquinone, thymol, pyrocatechol, triacontanyl palmitate, barturic acid, thiobarbituric acid, triazoles, 3-substitute-4-amino-5-thioxo-1H,4H-1,2,4-triazoles, alpha-hydroxyketones, alpha-diketones, hydroxyurea, triketone oximes, boric acid or salts or derivatives thereof, sodium or other salts of sulfate, sodium or other salts of benzenesulfinate, sodium or other salts of benzenesulfonate, sodium or other salts of sulfite, iodoacetic acid, N-ethylmaleimide, p-hydroxymercuribenzoate, p-chloromercuribenzoate, biscoumarin, a 1,2,4-thiadiazol-5-thio compound or derivatives thereof, a thiophosphoric acid triamide according to the general formula (Ia)

R¹R²N—P(X)(NH₂)₂ (Ia)

wherein
X is sulfur;
R¹ and R² are, independent from each other, selected from the group consisting of hydrogen, substituted or unsubstituted 2-nitrophenyl, C₁-C₂₀ alkyl, C₃-C₂₀ cycloalkyl, C₆-C₂₀ heterocycloaryl, C₆-C₂₀ aryl, or a dialkylaminocarbonyl group, wherein R¹ and R² together with the nitrogen atom linking them may also define a 5- or 6-membered saturated or unsaturated heterocyclic radical which optionally comprises 1 or 2 further heteroatoms selected from the group consisting of nitrogen, oxygen, and sulfur, such as pyrrolidinyl, piperazinyl, piperidinyl or morpholinyl;

a phosphoric acid triamide according to the general formula (Ib)

R¹R²N—P(Y)(NH₂)₂ (Ib)

wherein
Y is oxygen;
   R¹ and R² are, independent from each other, selected from the group consisting of hydrogen, substituted or unsubstituted 2-nitrophenyl, C₁-C₂₀ alkyl, C₃-C₂₀ cycloalkyl, C₆-C₂₀ heterocycloaryl, C₆-C₂₀ aryl, or a dialkylaminocarbonyl group, wherein R¹ and R² together with the nitrogen atom linking them may also define a 5- or 6-membered saturated or unsaturated heterocyclic radical which optionally comprises 1 or 2 further heteroatoms selected from the group consisting of nitrogen, oxygen, and sulfur, such as pyrrolidinyl, piperazinyl, piperidinyl or morpholinyl;

an adduct of N-(n-butyl) thiophosphoric acid triamide (NBPT), urea and formaldehyde, an adduct of N-(n-butyl) thiophosphoric acid triamide (NBPT), urea and formaldehyde according to the formula (Ic),

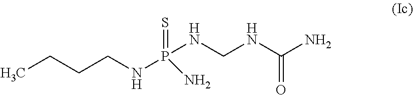

an adduct of N-(n-butyl) thiophosphoric acid triamide (NBPT), urea and formaldehyde according to the formula (Id),

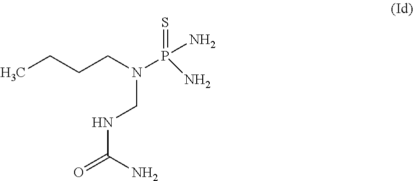

an adduct of N-(n-butyl) thiophosphoric acid triamide (NBPT), urea and formaldehyde according to the formula (Ie),

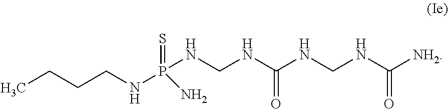 [SMILES: CCCCNP(N)(=S)NCNC(=O)NCNC(N)=O]

An adduct of N-(n-butyl) thiophosphoric acid triamide (NBPT), urea and formaldehyde, as well as the adducts according to the formulae (Ic), (Id) and (le) have been disclosed in WO17/019528.

Fertilizers which are suitable to combine them with urease inhibitors are urea-containing fertilizers, as described above.

Examples of denitrification inhibitors include e.g. type A proanthocyanidines, type B proanthocyanidines, oligomers of catechin, oligomers of epicatechin, tannins and strobilurin compounds such as pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide.

Fertilizers which are suitable to combine them with denitrification inhibitors are all N-containing fertilizers, as described above.

The efficacy of various nitrogen-stabilizing additive is dependent on specific conditions, thus showing variable potency. For example, while under a given set of parameters a nitrification inhibitor may preferably be used, under another set of parameters a urease inhibitor or denitrification inhibitor may preferably be used. Therefore, in an embodiment, step (c) is carried out for nitrification inhibitors, urease inhibitors and denitrification inhibitors and step (d) includes a recommendation whether a nitrification inhibitor, urease inhibitor or denitrification inhibitor is to be applied or no inhibitor is necessary. Advantageously, the recommendation is calculated based on the type of fertilizer used, the climate and weather forecast, the season of fertilization, the type of the crop and/or the geographical position of the field.

Nitrification rates in the soil are strongly influenced by the soil temperature and moisture, for example, increasing by a factor of 3 to 4 for each 10° C. increase between 5 and 25° C. Therefore, in an embodiment, parameters include the soil temperature, and an increase in temperature results in an increase of the calculated amount of nitrogen-stabilizing additive to be applied.

Considering the conversion of ammonium to nitrate, it has been found that at low temperatures, this conversion takes place relatively slowly, at higher temperatures very quickly. Due to the inhibitor, which is added to the fertilizer as an active ingredient, the ammonium remains longer in the soil.

According to the method of the present invention, a further parameter is used for calculating the necessary amount of nitrogen-stabilizing additive that may, for example, be the amount of precipitation.

Nitrification rates in the soil are strongly influenced by moisture. Therefore, in an embodiment, the parameters include the time interval until forecasted rainfall, and/or forecasted rainfall quantity, and a decrease of the time interval until forecasted rainfall and/or an increase in forecasted rainfall quantity results in an increase of the amount of nitrification inhibitor to be applied, a decrease of the calculated amount of urease inhibitor to be applied and/or an increase of the calculated amount of denitrification inhibitor to be applied.

If, for example, the weather forecast predicts no rainfall from day 1 to day 3 but it shall rain on day 4, on days 1 to 3, ammonia losses are to be expected. On the fourth day, the fertilizer is washed in and ammonia losses are reduced. Therefore, a urease inhibitor is only needed for four days. If such considerations are combined with, for example, the parameter of temperature or a parameter of the soil condition, a highly accurate calculation of the necessary amount of nitrogen-stabilizing additive may be carried out by the method of the present invention.

In addition, if no precipitation is to be expected for the next fourteen days, ammonia losses are to be expected to inhibit urease activity for this longer period. In such a case, a large amount of urease inhibitor is required. Moreover, if precipitation is expected shortly, the fertilizer is washed in and the ammonia losses are reduced. In such a case, no urease inhibitor is needed at all but a nitrification inhibitor would be more suitable.

High clay content is known to reduce NH₃ emission. Therefore, in an embodiment, parameters include the soil clay content and/or the soil sand content, and an increase of soil clay content and/or a decrease of soil sand content results in an increase of the calculated amount of nitrification inhibitor to be applied, a decrease of the calculated amount of urease inhibitor to be applied and/or an increase of the calculated amount of denitrification inhibitor to be applied.

The present invention further relates to a method for controlling the application of a nitrogen-stabilizing additive on a field selected from nitrification inhibitors, urease inhibitors and denitrification inhibitors, to be applied jointly or separately with a nitrogen-containing fertilizer. The method comprises the steps of determining an amount of nitrogen-containing fertilizer that is to be applied on the field, determining an amount of a nitrogen-stabilizing additive that is to be applied on the field by the above-described method and applying the nitrogen-containing fertilizer and the nitrogen-stabilizing additive in a ratio based on the determined amounts of the nitrogen-containing fertilizer and the nitrogen-stabilizing additive.

According to an embodiment of this method, it further comprises the steps of dividing the field in local sectors, determining said values of said at least two parameters separately for at least two local sectors, determining the amount of a nitrogen-containing fertilizer that is to be applied on the field separately for said at least two local sectors, detecting a geographical position during said application of the nitrogen-containing fertilizer and the nitrogen-stabilizing additive and determining the present local sector in which the detected geographical position falls, and applying the nitrogen-containing fertilizer and the nitrogen-stabilizing additive in a ratio based on the determined amounts of the nitrogen-containing fertilizer and the nitrogen-stabilizing additive for said determined present local sector.

It has been found that although the fertilizer can be applied evenly on the field, the nitrogen-stabilizing additive may be applied differently for each sector because, for example, certain parameters are different for each sector. The fertilizer can also be applied sector-specifically. In this case, the ratio of the stabilizer to the fertilizer may be calculated.

According to the invention the above-referenced object is also achieved by an apparatus for determining an amount of a nitrogen-stabilizing additive selected from nitrification inhibitors, urease inhibitors and denitrification inhibitors, to be applied jointly or separately with a nitrogen-containing fertilizer, comprising an input unit for determining values of at least two parameters influencing the efficacy of the nitrogen-stabilizing additive and for determining an amount of nitrogen-containing fertilizer that has been applied or is to be applied. Further the apparatus comprises an analyzing unit coupled with the input unit for determining the efficacy of the nitrogen-stabilizing additive on the basis of said values of said at least two parameters and a calculation unit coupled with the analyzing unit for calculating the necessary amount of nitrogen-stabilizing additive to be applied on the basis of said efficacy of the nitrogen-stabilizing additive and of said amount of nitrogen-containing fertilizer. Finally, the apparatus comprises an output unit coupled with the calculation unit for outputting the calculated amount of nitrogen-stabilizing additive to be applied.

The apparatus is particularly adapted for carrying out the method of the present invention. Therefore, the apparatus has the same advantages as the method of the present invention.

According to an embodiment, the input unit may comprise an interface for receiving data from an external database for determining said values. The external database may store a table with the values of the parameters to be considered by the analyzing unit. Therefore, several apparatuses at different locations may remotely access the external database by network technology. For example, data from the external database may be transferred to the input units of local apparatuses via the internet.

According to a further embodiment, the apparatus further comprises a sensor unit that is coupled with the input unit. The sensor unit is adapted to determine at least one value of said at least two parameters. The sensor unit may be integrated in the apparatus or remotely be coupled to the input unit of the apparatus. Furthermore, the input unit may be coupled to a unit providing satellite data, for example for determining the soil temperature at different locations.

The apparatus may be a mobile communication apparatus, such as a mobile phone, smartphone or a tablet computer, or a personal computer, laptop, computer kiosk (e.g., at a brick and mortar fertilizer store), or any other computing device. It is therefore possible that the farmer determines the necessary amount of nitrogen-stabilizing additive directly on the field when applying said additive.

In some embodiments of the present invention, the method and/or apparatus provide a user interface and workflow that enables users to identify an amount of nitrification-inhibiting additive to be applied. The apparatus may include a computing device that presents a user interface (e.g. a GUI) to a user that provides the user with an option to select a particular nitrogen-stabilizing additive (e.g., chemical species and formulation) and to input the user's information. The user interface may be presented via a web page or via a dedicated application running on a client machine. The computing device receives the particular selection and/or the user's information. The computing device determines an amount of nitrogen-stabilizing additive to be applied.

For example, the system architecture includes a server machine connected to client machines via a network. The client machines may be embodiments of the apparatus of the present invention. The network may be a public network (e.g., the Internet), a private network or wide area network (WAN)), or a combination thereof.

The client machines may run an operating system that manages hardware and software of the client machines. A browser may run on the client machines. The browser may be a web browser that can access content served by a web server. The browser may issue web page requests, search queries and/or other commands to the web server. Additionally, an application designed to communicate with web server may run on some of the client machines.

The present invention further relates to an application system for applying a nitrogen-stabilizing additive selected from nitrification inhibitors, urease inhibitors and denitrification inhibitors. This system comprises the above-described apparatus for determining an amount of a nitrogen-stabilizing additive, a first storage container for storing said nitrogen-stabilizing additive, and a discharging unit that is in data connection with said apparatus and that is adapted to discharge said nitrogen-stabilizing additive from said first storage container based on the calculated amount of nitrogen-stabilizing additive.

The application system may be used on the field so that the calculated amount of nitrogen-stabilizing additive is discharged on the field. Furthermore, the application system may be used in connection with a mixer. For example, the mixer mixes the fertilizer and the nitrogen-stabilizing additive by means of the application system.

According to an embodiment, the application system further comprises a second storage container for storing a nitrogen-containing fertilizer, wherein said discharging unit comprises a first unit for discharging said nitrogen-stabilizing additive from the first storage container and a second unit for separately discharging the nitrogen-containing fertilizer from the second storage container.

For example, the application system may be mounted on a vehicle. In this case, the first unit may be a field sprayer for spraying a liquid nitrogen-stabilizing additive on the field. The second unit may be a spreading device for spreading a solid fertilizer on the field. Preferably, the field sprayer is arranged at the front of the vehicle and the solid fertilizer spraying device is arranged at the back of the vehicle relative to the direction of travel of the vehicle. Preferably, the field sprayer is arranged relatively to the solid fertilizer spraying device so that the liquid fertilizer additive is prevented from coming into contact with surfaces of the solid fertilizer spreading device, which also come into contact with the solid fertilizer.

The present invention further relates to a computer program product comprising instructions which, when the program is executed by a computer, cause the computer to carry out the method as described above. Moreover, the above-described method is particularly a computer-implemented method comprising the above-described steps.

Embodiments of the present invention are now described with reference to the drawings.

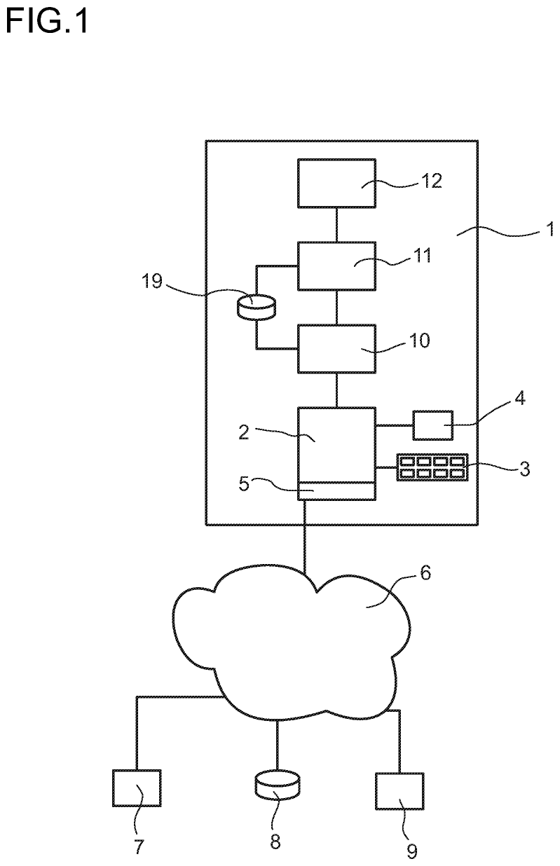

FIG. 1 shows an embodiment of the apparatus for determining an amount of a nitrogen-stabilizing additive according to the invention and

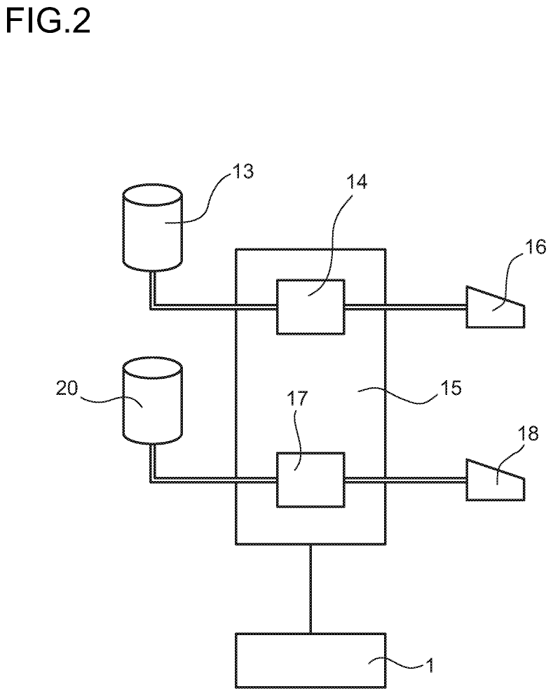

FIG. 2 shows an embodiment of the application system according to the present invention.

With reference to FIG. 1, the embodiment of the apparatus according to the invention is described:

The apparatus 1 comprises an input unit 2. The input unit 2 is coupled to an entry unit 3. The user may input data via entry unit 3.

The input unit 2 is further coupled to a sensor 4. Sensor 4 may be adapted to detect values of any parameter that directly or indirectly influences the efficacy of a nitrogen-stabilizing additive. In the present case, sensor 4 detects the geographical position of the apparatus 1. For example, sensor 4 is a GPS sensor. In further embodiments, input unit 2 may be coupled to further sensors not shown in FIG. 1.

The input unit 2 further comprises an interface 5 for data transfer via the internet 6. The interface 5 may be any kind of known communication interface such as an interface for a local area network (LAN), a wireless local area network (WLAN) or a telecommunication network.

By means of the interface 5, the apparatus can access remote sensors 7, an external database 8 as well as data providers 9. Remote sensors 7 may continuously detect values of parameters on the field. For example, external sensors 7 may detect the soil temperature, the soil pH, past amount and time of precipitation and actual wind strength.

The external database 8 may store data regarding the field and the crop that is grown on the field. For example, the external database 8 may comprise information as to the soil clay content, the soil sand content, soil pH, the organic matter content of the soil, soil compaction, biological activity of soil, CEC (cation exchange capacity) and total nitrogen content of soil, nitrate and/or ammonium content of soil, the type of cultivated plant, amount of precipitation, time of amount of precipitation, time interval until forecasted rainfall, forecasted rainfall quantity, wind strength and/or geographical position. Furthermore, the external database may comprise information as to the time interval between nitrogen-containing fertilizer application and nitrogen-stabilizing additive application. However, this information may also be input by the user by means of the entry unit 3.

By means of the data providers 9, the input unit 2 may access particularly forecasts of future values of parameters that are directly or indirectly relevant for the efficacy of the nitrogen-stabilizing additive. For example, external data providers 9 may provide information as to the time interval until forecasted rainfall and forecasted rain quantity. Furthermore, data providers 9 may provide information as to forecasted temperatures at different locations.

The data provided by the remote sensors 7, the external database 8 and data providers 9 are transferred via the internet 6 and the interface 5 to the input unit 2, wherein these data are summarized with the data provided by sensor 4 and entry unit 3.

These data have in common that their values influence directly or indirectly the efficacy of a nitrogen-stabilizing additive that shall be applied to a field.

Furthermore, the input unit 2 determines an amount of nitrogen-containing fertilizer that has been applied or is to be applied. For this purpose, the input unit 2 may be coupled to a discharging unit for discharging the nitrogen-containing fertilizer in order to receive data as to the amount of such fertilizer that has been applied. Alternatively or in addition, the user may enter via entry unit 3 the type and amount of fertilizer that shall be applied. Furthermore, in this case, the user enters the presumptive time of application of such fertilizer.

The input unit 2 is coupled to an analyzing unit 10. The analyzing unit 10 determines the efficacy of the nitrogen-stabilizing additive on the basis of the values of the parameters that have been determined by the input unit 2. It will be described later as to how the analyzing unit determines this efficacy.

The analyzing unit 10 is coupled to a calculation unit 11. The calculation unit 11 calculates the necessary amount of nitrogen-stabilizing additive to be applied. This calculation is based on the efficacy of the nitrogen-stabilizing additive as determined by the analyzing unit 10. Furthermore, the calculation takes the amount of nitrogen-containing fertilizer that has been applied or that is to be applied into account. It will be described later as to how the amount of nitrogen-stabilizing additive is calculated by the calculation unit 11.

The analyzing unit 10 and the calculation unit 11 are coupled to an internal database 19. The internal database 19 stores tables indicating the influence of several parameters on the efficacy of the nitrogen-stabilizing additive and the influence on the necessary amount of nitrogen-stabilizing additive as it will be described later.

The calculation unit 11 is coupled to an output unit 12. The output unit 12 outputs the calculated amount of nitrogen-stabilizing additive to be applied. The output unit 12 may be a display. Furthermore, the output unit 12 may comprise an interface in order to transfer data to a discharging unit of an application system as it will be described later.

The apparatus 1 may be integrated in a computer, in particular in a laptop, in a tablet computer or a smartphone.

In the following, an embodiment of the method of the present invention is described. The method may be carried out by the embodiment of apparatus 1 as described above.

In a first step, values of at least two parameters influencing the efficacy of the nitrogen-stabilizing additive are determined. This step is carried out by the input unit 2 as described above. The parameters include two or more of soil temperature, soil clay content, soil sand content, soil pH, organic matter content of the soil, soil compaction, biological activity of soil, CEC (cation exchange capacity) and total nitrogen content of soil, nitrate and/or ammonium content of soil, type of cultivated plant, amount of precipitation, time of amount of precipitation, time interval until forecasted rainfall, forecasted rainfall quantity, wind strength, geographical position, and the time interval between nitrogen-containing fertilizer application and prospected nitrogen-stabilizing additive application.

In a second step, the amount of nitrogen-containing fertilizer that has been applied and/or that is to be applied is determined. This determination is carried out by receiving a user's entry or by a data transfer within an application system. In addition, the time of an application or the time of an estimated application of the nitrogen-containing fertilizer is determined.

In a third step, the efficacy of the nitrogen-stabilizing additive is determined by analyzing unit 10 on the basis of the values of the parameters that have been determined in the first step. According to the embodiment, this third step is carried out for nitrification inhibitors, urease inhibitors and denitrification inhibitors separately.

In a fourth step, the necessary amount of nitrogen-stabilizing additive to be applied is calculated by calculation unit lion the basis of the determined efficacy of the nitrogen-stabilizing additive and the determined amount of nitrogen-containing fertilizer application. This step may also include a recommendation whether a nitrification inhibitor, a urease inhibitor or a denitrification inhibitor or no inhibitor is to be applied. Furthermore, the calculation may take the time of the nitrogen-containing fertilizer application into account. Moreover, the calculation may take the temporal development of the values of one or more parameters into account.

In a fifth step, the calculating amount of nitrogen-stabilizing additive may be output by a display or an interface.

In the following, it is described as to how the efficacy of the nitrogen-stabilizing additive is determined on the basis of the values of the above-mentioned parameters and as to how the necessary amount of nitrogen-stabilizing additive is calculated:

The analyzing unit 10 and the calculation unit 11 are coupled to the internal database 19 that stores tables indicating the influence of several parameters on the efficacy of the nitrogen-stabilizing additive and the influence on the necessary amount of nitrogen-stabilizing additive. The values are stored separately for nitrification inhibitors, urease inhibitors and denitrification inhibitors.

The following Table 1 shows the influence of different weather conditions on the efficacy of nitrification inhibitors and whether a value of the parameter increases or decreases the necessary amount of nitrification inhibitor:

TABLE 1

| Influence of | | |
|---|---|---|
| weather | Amount of nitrification | Amount of nitrification |
| conditions | inhibitor is increased | inhibitor is decreased |
| Temperature | Warm (faster reduction of | Cold (slighter reduction |
| | nitrification inhibitor) | of nitrification inhibitor) |
| Precipitation | High (more nitrate is | Low or non-existent (no |
| | leached) | NO₃ leaching) |
| Time until | Short (fast effect of | Long (no or only slight |
| precipitation | nitrification inhibitor | leaching of NO₃) |
| | necessary) | |
| Wind strength | High (possibly, gaseous | Low or non-existent (no |
| | losses of nitrification | gaseous losses of |
| | inhibitor) | nitrification inhibitor) |

The following Table 2 shows the influence of different weather conditions on the efficacy of urease inhibitors and whether a value of the parameter increases or decreases the necessary amount of urease inhibitor:

TABLE 2

| Influence of | Amount of urease | Amount of urease |
|---|---|---|
| weather | inhibitor | inhibitor |
| conditions | is increased | is decreased |
| Temperature | Warm (faster reduction of | Cold (slighter reduction of |
| | urease inhibitor, higher | urease inhibitor, smaller |
| | losses of NH₃) | losses of NH₃) |
| Precipitation | Low or non-existent (no | High (NH₃ leaching into |
| | NH₃ leaching into the soil) | the soil, no NH₃ losses) |
| Time until | Long (high NH₃ losses, | Short (small losses, since |
| precipitation | since no NH₃ leaching) | NH3 leaching) |
| Wind strength | High (gas balance | Low or non-existent (no |
| | disturbed to the | gaseous imbalance with |
| | disadvantage of the NH₃ | nitrogen emissions) |
| | losses) | |

The following Table 3 shows the influence of different weather conditions on the efficacy of denitrification inhibitors and whether a value of the parameter increases or decreases the necessary amount of denitrification inhibitor:

TABLE 3

| | Amount of | Amount of |
|---|---|---|
| Influence of weather | denitrification | denitrification |
| conditions | inhibitor is increased | inhibitor is decreased |
| Temperature | Warm (faster reduction) | Cold (smaller reduction of |
| | | denitrification inhibitor) |
| Precipitation | High (enhances reducing | Low or non-existent (no |
| | conditions) | reducing conditions) |
| Time until | Short (enhances reducing | Long (no reducing |
| precipitation | conditions) | conditions for a long time) |
| Wind strength | Neutral (incorporated in | Neutral (incorporated in |
| | the soil)/high | the soil)/low |

The following Table 4 shows the influence of different soil-related parameters on the efficacy of nitrification inhibitors and whether a value of the parameter increases or decreases the necessary amount of nitrification inhibitor:

TABLE 4

| Soil-related | Amount of nitrification | Amount of nitrification |
|---|---|---|
| parameter | inhibitor is increased | inhibitor is decreased |
| Type of soil | Clayey (less NO₃ | Sandy (better efficacy of |
| | leaching) | nitrification inhibitor on |
| | | sandy soils) |
| pH value | Neutral (negligible | Neutral (negligible |
| | influence on nitrification | influence on nitrification |
| | inhibitor activity) | inhibitor activity) |
| Organic matter | High (nitrification inhibitor | Low (nitrification inhibitor |
| content of the soil | is bound) | is less bound) |
| Biological activity | High (faster reduction of | Low (nitrification inhibitor |
| | nitrification inhibitor) | is retained longer) |
| Urease activity | Neutral (no influence on | Neutral (no influence on |
| | nitrification inhibitors) | nitrification inhibitors) |
| Nitrate content in | Neutral | Neutral |
| the soil | | |
| Soil compaction | Neutral | Neutral |

The following Table 5 shows the influence of different soil-related parameters on the efficacy of urease inhibitors and whether a value of the parameter increases or decreases the necessary amount of urease inhibitor:

TABLE 5

| Soil-related | Amount of urease | Amount of urease |
|---|---|---|
| parameter | inhibitor is increased | inhibitor is decreased |
| Type of soil | Sandy (lower cation | Clayey (high cation |
| | exchange capacity) | exchange capacity) |
| pH value | High (NH₄/NH₃ balance on | Low (NH₄/NH₃ balance |
| | the part of NH₃) | on the part of NH₄) |
| Organic matter | High (urease inhibitor is | Low (less bonding of |
| conten tof the | bound, higher urease | urease inhibitor, urease |
| soil | activity) | inhibitor more mobile) |
| Biological | High (faster reduction of | Low (urease inhibitor is |
| activity | urease inhibitor) | retained longer) |
| Urease activity | High (resulting in high NH₃ | Low (resulting in small |
| | losses) | NH₃ losses) |
| Nitrate content | Neutral | Neutral |
| in the soil | | |
| Soil compaction | Neutral | Neutral |

The following Table 6 shows the influence of different soil-related parameters on the efficacy of denitrification inhibitors and whether a value of the parameter increases or decreases the necessary amount of denitrification inhibitor:

TABLE 6

| Soil-related | Amount of denitrification | Amount of denitrification |
|---|---|---|
| parameter | inhibitor is increased | inhibitor is decreased |
| Type of soil | Clayey (more reducing | Sandy (low risk of soil |
| | zones) | compactions) |
| pH value | Neutral (influence not | Neutral (influence not |
| | known) | known) |
| Organic matter | Low (denitrification | High (less bonding of |
| content of the | inhibitor is bound, smaller | denitrification inhibitor, |
| soil | risk of compactions) | higher risk of compaction) |
| Biological | High (faster reduction of | Low (denitrification |
| activity | denitrification inhibitor) | inhibitor is retained longer) |
| Urease activity | Neutral (no influence on | Neutral (no influence on |
| | denitrification inhibitors) | denitrification inhibitors) |
| Nitrate content | High (NO₃ is origin of | Low (NO₃ is origin of |
| in the soil | denitrification losses) | denitrification losses) |
| Soil compaction | Existent (formation of | Non-existent (negligible or |
| | reducing zones) | non-existent reducing |
| | | zones) |

The following Table 7 shows the influence of different cultivation parameter parameters on the efficacy of nitrification inhibitors and whether a value of the parameter increases or decreases the necessary amount of nitrification inhibitor:

TABLE 7

| Cultivation | Amount of nitrification | Amount of nitrification |
|---|---|---|
| parameter | inhibitor is increased | inhibitor is decreased |
| Time of liming | Neutral | Neutral |
| Crop residues | Neutral | Neutral |
| Soil cultivation | Neutral | Neutral |

The following Table 8 shows the influence of different cultivation parameters on the efficacy of urease inhibitors and whether a value of the parameter increases or decreases the necessary amount of urease inhibitor:

TABLE 8

| Cultivation | Amount of urease inhibitor | Amount of urease inhibitor |
|---|---|---|
| parameter | is increased | is decreased |
| Time of liming | Comparatively recent (pH | Comparatively long ago |
| | increasing) | (pH rather lower) |
| Crop residues | Many (high urease | Little (low urease activity) |
| | activity) | |
| Soil tillage | Ploughless cultivation | Regular ploughing (lower |
| | (more organic matter and | urease activity) |
| | higher urease activity) | |

The following Table 9 shows the influence of different cultivation parameters on the efficacy of denitrification inhibitors and whether a value of the parameter increases or decreases the necessary amount of denitrification inhibitor:

TABLE 9

| Cultivation | Amount of denitrification | Amount of denitrification |
|---|---|---|
| parameter | inhibitor is increased | inhibitor is decreased |
| Time of | Neutral to comparatively | Neutral to comparatively |
| liming | long ago (liming results in | recent |
| | better soil structure with | |
| | less compactions) | |
| Crop | Little (higher risk of | Many (lower risk of |
| residues | compactions) | compactions) |
| Soil | Regular ploughing | Ploughless cultivation (low |
| cultivation | (“plough sole”) | risk of soil compactions) |

The following Table 10 shows the influence of fertilizer application parameters on the efficacy of nitrification inhibitors and whether a value of the parameter increases or decreases the necessary amount of nitrification inhibitor:

TABLE 10

| | Amount of | Amount of |
|---|---|---|
| | nitrification | nitrification |
| | inhibitor | inhibitor |
| Fertilization parameter | is increased | is decreased |
| Amount of fertilizer | High (the more fertilizer, | Low |
| | the higher the soil activity, | |
| | the higher the need of | |
| | nitrification inhibitor) | |
| Incorporation of fertilizer | Neutral | Neutral |
| Urea ammonium nitrate | Neutral | Neutral |
| solution/urea | | |
| Other fertilizer | Neutral | Neutral |
| containing NH4-N | | |

The following Table 11 shows the influence of fertilizer application parameters on the efficacy of urease inhibitors and whether a value of the parameter increases or decreases the necessary amount of urease inhibitor:

TABLE 11

| Fertilization | Amount of urease | Amount of urease |
|---|---|---|
| parameter | inhibitor is increased | inhibitor is decreased |
| Amount of fertilizer | High (the more fertilizer, | Low |
| | the higher the soil activity, | |
| | the higher the need of | |
| | urease inhibitor) | |
| Incorporation of | No (losses are reduced) | Yes |
| fertilizer | | |
| Urea ammonium | Yes (urea is basis of | No |
| nitrate solution/urea | urease inhibitor) | |
| Other fertilizer | No recommendation | No recommendation |
| containing NH4-N | | |

The following Table 12 shows the influence of fertilizer application parameters on the efficacy of denitrification inhibitors and whether a value of the parameter increases or decreases the necessary amount of denitrification inhibitor:

TABLE 12

| | Amount of | Amount of |
|---|---|---|
| | denitrification | denitrification |
| Fertilization | inhibitor is | inhibitor is |
| parameter | increased | decreased |
| Amount of fertilizer | High (the more fertilizer, | Low |
| | the higher the soil activity, | |
| | the higher the need of | |
| | nitrification inhibitor) | |
| Incorporation of | Neutral | Neutral |
| fertilizer | | |
| Urea ammonium | Neutral | Neutral |
| nitrate solution/urea | | |
| Other fertilizer | Neutral | Neutral |
| containing NH₄-N | | |

In the following, an example will be given for the calculation of the amount of nitrification inhibitor:

As parameters, the soil temperature and rainfall is taken into account for the calculation of the necessary amount of nitrification inhibitor. It is assumed that the amount of nitrification inhibitor is calculated relative to a standard amount of nitrification inhibitor relative to a determined amount of nitrogen-containing fertilizer. This standard amount is assumed to be 100.

If the amount of rainfall is high, more nitrification inhibitor is needed, if the amount of rainfall is low, less nitrification inhibitor is needed. Furthermore, if the temperature is high relative to a standard value, even more nitrification inhibitor is needed.

The following Table 13 shows the influence of the development of the temperature and the rainfall within the next ten days on the relative concentration of nitrification inhibitor that is to be applied jointly or separately with a nitrogen-containing fertilizer:

TABLE 13

| | | Development of rainfall within the next 10 days | | | | | | | | |
|---|---|---|---|---|---|---|---|---|---|---|
| | | 0 | 2.5 | 5 | 7.5 | 10 | 12.5 | 15 | 17.5 | 20 |
| Development | −20 | 0 | 0 | 0 | 0 | 0 | 0 | 0 | 0 | 0 |
| of temperature | −15 | 0 | 0 | 0 | 0 | 0 | 0 | 0 | 0 | 0 |
| within the | −10 | 0 | 0 | 0 | 0 | 0 | 0 | 0 | 0 | 0 |
| next 10 days | −5 | 0 | 0 | 0 | 0 | 0 | 0 | 0 | 0 | 0 |
| | +/−0 | 0 | 0 | 100 | 100 | 105 | 105 | 110 | 110 | 115 |
| | 5 | 0 | 0 | 100 | 100 | 105 | 105 | 110 | 110 | 115 |
| | 10 | 0 | 0 | 102.5 | 105 | 110 | 110 | 115 | 115 | 120 |
| | 15 | 0 | 0 | 107.5 | 110 | 120 | 120 | 125 | 125 | 130 |
| | 20 | 0 | 0 | 115 | 120 | 125 | 125 | 130 | 130 | 135 |
| | 25 | 0 | 0 | 130 | 135 | 135 | 135 | 140 | 140 | 150 |
| | 30 | 0 | 0 | 180 | 200 | 220 | 240 | 260 | 280 | 300 |
| | 35 | 0 | 0 | 200 | 225 | 250 | 275 | 300 | 325 | 350 |

According to a further embodiment, Table 13 may not only be two-dimensional, but multidimensional if further parameters are taken into account. For example, the soil clay content, the soil sand content, the soil pH, and the organic matter content of the soil may be considered.

In the following, an example will be given for the calculation of the necessary amount of a urease inhibitor based on at least two parameters:

In this case, the soil temperature and the wind strength are considered as main parameters. If the temperature is high, more urease inhibitor is needed, if the temperature is low relative to a standard temperature value, less urease inhibitor is needed. If, in addition, the wind is strong relative to a standard wind strength value, more urease inhibitor is needed, if there is little wind, less urease inhibitor is needed.

In addition, rainfall may be taken into account. Table 14 shows the influence of the development of the temperature within the next 10 days and the rainfall within the next 5 days on the relative concentration of urease inhibitor:

TABLE 14

| | | Development of rainfall within the next 5 days | | | | | | | | |
|---|---|---|---|---|---|---|---|---|---|---|
| | | 0 | 2.5 | 5 | 7.5 | 10 | 12.5 | 15 | 17.5 | 20 |
| Development | −20 | 100 | 100 | 100 | 100 | 100 | 100 | 100 | 100 | 100 |
| of temperature | −15 | 100 | 100 | 100 | 100 | 100 | 100 | 100 | 100 | 100 |
| within the | −10 | 100 | 100 | 100 | 100 | 100 | 100 | 100 | 100 | 100 |
| next 10 days | −5 | 100 | 100 | 100 | 100 | 100 | 100 | 100 | 100 | 100 |
| | +/−0 | 100 | 100 | 100 | 100 | 100 | 105 | 110 | 115 | 0 |
| | 5 | 100 | 100 | 100 | 100 | 105 | 110 | 120 | 0 | 0 |
| | 10 | 100 | 100 | 102.5 | 105 | 110 | 115 | 0 | 0 | 0 |
| | 15 | 105 | 105 | 107.5 | 110 | 120 | 130 | 0 | 0 | 0 |
| | 20 | 110 | 110 | 115 | 120 | 125 | 0 | 0 | 0 | 0 |
| | 25 | 120 | 125 | 130 | 135 | 0 | 0 | 0 | 0 | 0 |
| | 30 | 150 | 175 | 200 | 225 | 0 | 0 | 0 | 0 | 0 |
| | 35 | 200 | 250 | 275 | 300 | 0 | 0 | 0 | 0 | 0 |

Also this table may be multidimensional if wind strength as well as soil cultivation, organic matter content of the soil, soil pH and urease activity are considered in addition.

Furthermore, an example is given for the calculation of the necessary amount of denitrification inhibitor:

In this case, the main parameters that are taken into account by the calculation of the amount of denitrification inhibitor are rainfall as well as soil compaction. The following Table 15 shows the influence of the soil compaction and the rainfall within the next 5 days on the relative concentration of the denitrification inhibitor:

TABLE 15

| | | Development of rainfall within the next 5 days | | | | | | | | |
|---|---|---|---|---|---|---|---|---|---|---|
| | | 0 | 2.5 | 5 | 7.5 | 10 | 12.5 | 15 | 17.5 | 20 |
| Soil compaction | −/+0 | 100 | 100 | 105 | 105 | 110 | 110 | 115 | 115 | 120 |
| (dry density g/cm³) | +2% | 100 | 100 | 105 | 105 | 110 | 110 | 115 | 115 | 120 |
| Deviation from | +4% | 100 | 101 | 107 | 107 | 115 | 115 | 120 | 120 | 125 |
| default value for | +6% | 100 | 102 | 107 | 107 | 115 | 115 | 120 | 120 | 125 |
| a soil (in %) | +8% | 100 | 103 | 110 | 110 | 120 | 120 | 125 | 125 | 130 |
| | +10% | 100 | 104 | 110 | 110 | 120 | 120 | 125 | 125 | 130 |
| | +12% | 100 | 105 | 113 | 113 | 125 | 125 | 130 | 130 | 135 |
| | +14% | 105 | 106 | 113 | 113 | 125 | 125 | 130 | 130 | 135 |
| | +16% | 110 | 107 | 115 | 115 | 130 | 130 | 145 | 145 | 160 |
| | +18% | 120 | 108 | 130 | 130 | 145 | 145 | 160 | 160 | 175 |
| | +20% | 150 | 109 | 200 | 200 | 225 | 225 | 250 | 250 | 300 |
| | +25% | 200 | 110 | 250 | 250 | 300 | 300 | 350 | 350 | 400 |

Also this table may be multidimensional if the type of soil, nitrate content, the biological activity of the soil and the type of soil cultivation (plough and the like) is considered.

According to a further embodiment, the field on which the nitrogen-stabilizing additive and the nitrogen-containing fertilizer are to be applied is to be divided into local sectors. In this case, the values of all of the parameters taken into account for the determination of the efficacy of the nitrogen-stabilizing additive and the calculation of the necessary amount of nitrogen-stabilizing additive are determined separately for at least two local sectors, in particular for all local sectors.

In this case, the amount of nitrogen-containing fertilizer is to be applied on the field separately for the local sectors. The method of this embodiment comprises the further step of detecting the geographical position during the application of the nitrogen-containing fertilizer and the nitrogen-stabilizing additive. For example, sensor 4 is used. It is then determined in which local sector the detected geographical position falls. The nitrogen-containing fertilizer and the nitrogen-stabilizing additive may then be applied in a ratio based on the determined amounts of the nitrogen-containing fertilizer and the nitrogen-stabilizing additive for the determined present local sector of the present geographical position.

With reference to FIG. 2, an embodiment of the application system for applying a nitrogen-stabilizing additive is described:

The application system comprises a discharging unit 15. This discharging unit 15 may be mounted on a vehicle that may travel over the field or may be attached to such vehicle. The discharging unit 15 comprises a first unit 14 and a second unit 17. Furthermore, the application system comprises a first storage container 13 for storing the nitrogen-stabilizing additive and a second storage container 20 for storing a nitrogen-containing fertilizer. The first unit 14 of the discharging unit 15 is designed to convey the nitrogen-stabilizing additive that is in particular liquid to a field sprayer 16 for spraying the liquid nitrogen-stabilizing additive on the field. Likewise, the second unit 17 of the discharging unit 15 is designed to convey the nitrogen-containing fertilizer that is solid from the second storage container 20 to a spreading device 18 for spreading the solid fertilizer on the field. The ratio of the amounts of nitrogen-stabilizing additive and nitrogen-containing fertilizer is calculated as described above. For this purpose, apparatus 1 as described above is coupled to the discharging unit 15 so that the determined amount of nitrogen-containing fertilizer as well as the calculated necessary amount of nitrogen-stabilizing additive is transferred to a control unit of the discharging unit 15.

### LIST OF REFERENCE SIGNS

1 apparatus
2 input unit
3 entry unit
4 sensor
5 interface
6 internet
7 remote sensors
8 external database
9 data providers
10 analyzing unit
11 calculation unit
12 output unit
13 first storage container
14 first unit
15 discharging unit
16 field sprayer
17 second unit
18 spreading device
19 internal database
20 second storage container

1. A method for determining an amount of a nitrogen-stabilizing additive selected from nitrification inhibitors, urease inhibitors and denitrification inhibitors, to be applied jointly or separately with a nitrogen containing fertilizer, comprising:
(a) determining values of at least two parameters influencing the efficacy of the nitrogen-stabilizing additive;
(b) determining an amount of nitrogen-containing fertilizer that has been applied or is to be applied;
(c) determining the efficacy of the nitrogen-stabilizing additive on the basis of said values of said at least two parameters; and
(d) calculating the necessary amount of nitrogen-stabilizing additive to be applied on the basis of said efficacy of the nitrogen-stabilizing additive and of said amount of nitrogen-containing fertilizer application.

2. The method according to claim 1, wherein:
the time of an application or the time of an estimated application of the nitrogen-containing fertilizer is determined; and
the necessary amount of nitrogen-stabilizing additive to be applied is calculated on the basis of said efficacy of the nitrogen-stabilizing additive and of said amount and time of the nitrogen-containing fertilizer application.

3. The method according to claim 1, wherein:
said parameters include two or more of soil temperature, soil clay content, soil sand content, soil pH, organic matter content of the soil, soil compaction, biological activity of soil, CEC (cation exchange capacity) and total nitrogen content of soil, nitrate and/or ammonium content of soil, type of cultivated plant, amount of precipitation, time of amount of precipitation, time interval until forecasted rainfall, forecasted rainfall quantity, wind strength, geographical position, and the time interval between nitrogen-containing fertilizer application and nitrogen-stabilizing additive application.

4. The method according to claim 1, wherein:
at least one value of said at least two parameters is provided by a user's input, by an automated access to a database (8) and/or by an automated measurement.

5. The method according to claim 1, wherein:
at least one value of said at least two parameters is provided by a forecast of a future value of this parameter.

6. The method according to claim 1, wherein:
step (c) is carried out for nitrification inhibitors, urease inhibitors and denitrification inhibitors, and
step (d) includes a recommendation whether a nitrification inhibitor, urease inhibitor or denitrification inhibitor is to be applied or no inhibitor is necessary.

7. The method according to claim 1, wherein:
said parameters include the soil temperature, and
an increase in the soil temperature results in an increase of the calculated amount of nitrogen-stabilizing additive to be applied.

8. The method according to claim 1, wherein:
said parameters include a time interval until forecasted rainfall, and/or a forecasted rainfall quantity, and
a decrease of the value of the time interval until forecasted rainfall and/or an increase of the value in the forecasted rainfall quantity results in an increase of the calculated amount of nitrification inhibitor to be applied, a decrease of the calculated amount of urease inhibitor to be applied and/or an increase of the calculated amount of denitrification inhibitor to be applied.

9. The method according to claim 1, wherein:
said parameters include a soil clay content and/or a soil sand content, and
an increase of the value of the soil clay content and/or a decrease of the value of the soil sand content results in an increase of the calculated amount of nitrification inhibitor to be applied, a decrease of the calculated amount of urease inhibitor to be applied and/or an increase of the calculated amount of denitrification inhibitor to be applied.

10. A method for controlling the application of a nitrogen-stabilizing additive on a field selected from nitrification inhibitors, urease inhibitors and denitrification inhibitors, to be applied jointly or separately with a nitrogen-containing fertilizer, comprising the steps of:
determining an amount of nitrogen-containing fertilizer that is to be applied on the field;
determining an amount of a nitrogen-stabilizing additive that is to be applied on the field by the method according to claim 1; and
applying the nitrogen-containing fertilizer and the nitrogen-stabilizing additive in a ratio based on the determined amounts of the nitrogen-containing fertilizer and the nitrogen-stabilizing additive.

11. The method according to claim 10, further comprising the steps of:
dividing the field in local sectors;
determining said values of said at least two parameters separately for at least two local sectors;
determining the amount of nitrogen-containing fertilizer that is to be applied on the field separately for said at least two local sectors;
detecting a geographic position during said application of the nitrogen-containing fertilizer and the nitrogen-stabilizing additive and determining the present local sector in which the detected geographical position falls; and
applying the nitrogen-containing fertilizer and the nitrogen-stabilizing additive in a ratio based on the determined amounts of the nitrogen-containing fertilizer and the nitrogen-stabilizing additive for said determined present local sector.

12. An apparatus (1) for determining an amount of a nitrogen-stabilizing additive selected from nitrification inhibitors, urease inhibitors and denitrification inhibitors, to be applied jointly or separately with a nitrogen-containing fertilizer, comprising:
an input unit (2) for determining values of at least two parameters influencing the efficacy of the nitrogen-stabilizing additive and for determining an amount of nitrogen-containing fertilizer that has been applied or is to be applied;
an analyzing unit (10) coupled with the input unit (2) for determining the efficacy of the nitrogen-stabilizing additive on the basis of said values of said at least two parameters;
a calculation unit (11) coupled with the analyzing unit (10) for calculating the necessary amount of nitrogen-stabilizing additive to be applied on the basis of said efficacy of the nitrogen-stabilizing additive and of said amount of nitrogen-containing fertilizer; and
an output unit (12) coupled with the calculation unit (11) for outputting the calculated amount of nitrogen-stabilizing additive to be applied.

13. An application system for applying a nitrogen-stabilizing additive selected from nitrification inhibitors, urease inhibitors and denitrification inhibitors comprising:
an apparatus (1) according to claim 12;
a first storage container (13) for storing said nitrogen-stabilizing additive; and
a discharge unit (15) that is in data connection with said apparatus (1) and that is adapted to discharge said nitrogen-stabilizing additive from said first storage container (13) based on the calculated amount of nitrogen-stabilizing additive.

14. The application system of claim 13, further comprising:
a second storage container (20) for storing a nitrogen-containing fertilizer, wherein said discharge unit (15) comprises a first unit (14) for discharging said nitrogen-stabilizing additive from said first storage container (13) and a second unit (17) for separately discharging said nitrogen-containing fertilizer from said second storage container (20).

15. A computer program product comprising non-transitory computer-readable instructions which, when the program is executed by a computer, cause the computer to carry out the method of claim 1.
